(19) United States
(12) Patent Application Publication
(10) Pub. No.: US 2012/0182919 A1
(43) Pub. Date: Jul. 19, 2012

(54) Method of Handling Latency Impact on Feedback Operation and Related Communication Device

(76) Inventor: Yu-Chih Jen, Taoyuan County (TW)

(21) Appl. No.: 13/351,245

(22) Filed: Jan. 17, 2012

Related U.S. Application Data
(60) Provisional application No. 61/433,277, filed on Jan. 17, 2011.

(51) Int. Cl. H04W 4/06; H04W 72/04

(52) U.S. Cl. 370/312

(57) ABSTRACT

A method of handling control information for a mobile device in a wireless communication system is disclosed. The mobile device is configured with a coordinated multipoint transmission/reception (CoMP) operation by network of the wireless communication system. The method comprises determining at least one cooperating cell or cooperating point of the network involving in the CoMP operation or involving in downlink (DL) transmissions to the mobile device or uplink (UL) receptions from the mobile device; and feeding back the control information to the at least one cooperating cell or cooperating point on at least one UL channel.

### CROSS REFERENCE TO RELATED APPLICATIONS

This application claims the benefit of U.S. Provisional Application No. 61/433,277, filed on Jan. 17, 2011 and entitled “Method and Apparatus to Mitigate Latency Impact on CoMP HARQ and Feedback Operation”, the contents of which are incorporated herein in their entirety.

### BACKGROUND OF THE INVENTION

1. Field of the Invention

The present invention relates to a method used in a wireless communication system and related communication device, and more particularly, to a method of handling latency impact on feedback operation and related communication device.

2. Description of the Prior Art

A long-term evolution (LTE) system supporting the 3GPP Rel-8 standard and/or the 3GPP Rel-9 standard are developed by the 3rd Generation Partnership Project (3GPP) as a successor of a universal mobile telecommunications system (UMTS), for further enhancing performance of the UMTS to satisfy increasing needs of users. The LTE system includes a new radio interface and a new radio network architecture that provides a high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple UEs, and communicates with a core network including a mobility management entity (MME), a serving gateway, etc., for Non Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint transmission/reception (CoMP), UL multiple-input multiple-output (MIMO), etc. For a UE and an eNB to communicate with each other in the LTE-A system, the UE and the eNB must support standards developed for the LTE-A system, such as the 3GPP Rel-10 standard or later versions.

When the CoMP is configured to a UE and multiple cells (e.g. cooperating network points), the UE may communicate with the cells simultaneously, i.e., access a service via all or part of the cells. More specifically, an eNB may manage only one cell, or may manage multiple cells (e.g. via remote radio head (RRH)). That is, Cell IDs of different cells may be different (e.g. when being managed by different eNBs or the same eNB), or may be the same (e.g. when being managed by different eNBs or the same eNB). Thus, signals transmitted between the UE and the cells can be easily recovered due to better quality of the signals. In detail, the cells involved in the CoMP can be denoted as cooperating cells, wherein one of the cooperating cells is a serving cell. In general, link quality between the serving cell and the UE is better than those between other cooperating cells and the UE. Control information required for the CoMP is usually transmitted by the UE to the serving cell first. Then, the serving cell exchanges the control information with other cooperating cells such that the CoMP can operate regularly. Further, the CoMP can be classified into two main categories: Joint Processing (JP) and Coordinated Scheduling/Beamforming (CS/CB). A main difference between the JP and the CS/CB is that data of the UE is available at all the cooperating cells when the JP is configured (i.e. enabled), while the data of the UE is only available at the serving cell when the CS/CB is configured. The JP can be further divided into two categories: joint transmission and dynamic cell selection. When the joint transmission is configured, the data of the UE can be transmitted from multiple cooperating cells (e.g. coherently or noncoherently) to the UE to improve signal quality and/or cancel interferences. When the dynamic cell selection is configured, the data of the UE is transmitted from only one of the cooperating cells (e.g. according to a choice or suggestion of the UE) to the UE to improve signal quality and/or avoid the interferences. On other hand, when the CS/CB is configured, the data of the UE is only transmitted from the serving cell to the UE, while other cooperating cells may stop transmissions or adjust beamforming to mitigate the interferences.

A hybrid automatic repeat request (HARQ) process is used in the LTE system and the LTE-A system to provide both efficient and reliable data transmissions. Different from an ARQ process, an error correction code (ECC) (e.g. a convolutional code) is used in the HARQ process. For example, a receiver (e.g. a UE) feeds back an acknowledgment (ACK) to inform a transmitter (e.g. a cell) that a packet has been received correctly if the receiver decodes the packet correctly. Oppositely, the receiver feeds back a negative acknowledgment (NACK) to the transmitter if the receiver cannot decode the packet correctly. In this situation, the receiver stores part or all of the packet in a soft buffer of the receiver. After the receiver receives a retransmitted packet from the transmitter, the receiver decodes the part or all of the packet and the retransmitted packet jointly. The receiver continues the HARQ process until the packet is decoded correctly. Since the packet with the small errors can be correctly decoded by using the ECC without feeding back the NACK, i.e., requesting a retransmission, throughput of the communication system is increased due to fewer retransmissions.

However, when the HARQ process is performed, the CoMP may not operate regularly due to a coordination latency. In detail, after a serving cell receives control information from a UE, the serving cell and other cooperating cells need to exchange necessary information (e.g. data, coordinated control information, scheduling and/or resource allocation) such that the CoMP can operate regularly. However, the HARQ process (e.g. transmissions or receptions) is performed according to a round-trip time (RTT) defined in the 3GPP standard, and the RTT may not be sufficient for exchanging the necessary information. In other words, the cooperating cells may need to perform the HARQ process, before the necessary information is completely exchanged. More specifically, the CoMP may operate by using the control information which is wrong, expired or incomplete, and performance of the CoMP is degraded. Therefore, how to solve the problem of the coordination latency is a topic to be discussed and addressed.

### SUMMARY OF THE INVENTION

The present invention therefore provides a method and related communication device for handling latency impact on feedback operation to solve the abovementioned problems.

A method of handling control information for a mobile device in a wireless communication system is disclosed. The mobile device is configured with a coordinated multipoint transmission/reception (CoMP) operation by network of the wireless communication system. The method comprises determining at least one cooperating cell or cooperating point of the network involving in the CoMP operation or involving in downlink (DL) transmissions to the mobile device or uplink (UL) receptions from the mobile device; and feeding back the control information to the at least one cooperating cell or cooperating point on at least one UL channel.

A method of handling control information for a mobile device in a wireless communication system is disclosed. The mobile device is configured with a coordinated multipoint transmission/reception (CoMP) operation by network of the wireless communication system. The method comprises receiving the control information on at least one downlink (DL) channel from at least one cooperating cell or cooperating point of the network; and determining the at least one cooperating cell or cooperating point of the network according to a configuration indicated by the network, wherein the control information is transmitted by the at least one cooperating cell or cooperating point to the mobile device.

A method of handling at least one uplink (UL) coordinated multipoint transmission/reception (CoMP) transmission or signaling for a mobile device in a wireless communication system is disclosed. The mobile device is configured with a CoMP operation by a network of the wireless communication system. The method comprises determining at least one cooperating cell or cooperating point of the network involving in receiving the at least one UL CoMP transmission or signaling from the mobile device or involving in the CoMP operation; and transmitting the at least one UL CoMP transmission or signaling to the at least one cooperating cell or cooperating point on at least one UL channel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a schematic diagram of communication protocol layers for an exemplary wireless communication system.

FIG. 4 is a flowchart of a process according to an example of the present invention.

FIG. 5 is a flowchart of a process according to an example of the present invention.

FIG. 6 is a flowchart of a process according to an example of the present invention.

### DETAILED DESCRIPTION

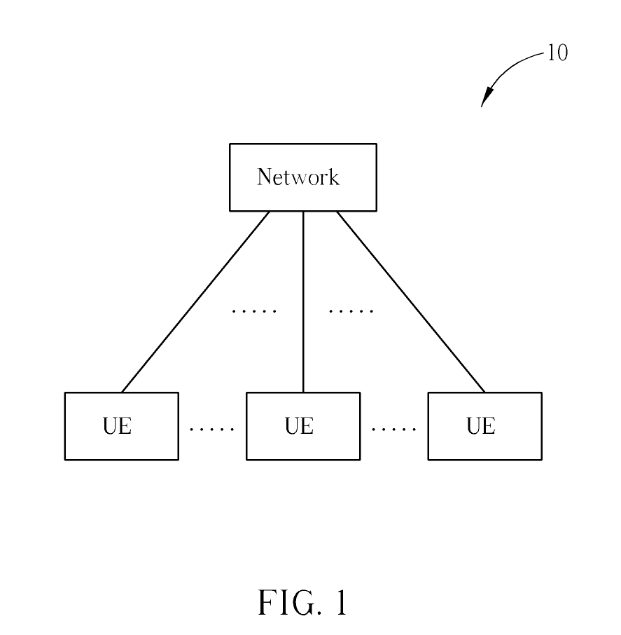

Please refer to FIG. 1, which is a schematic diagram of a wireless communication system 10 according to an example of the present invention. The wireless communication system 10 is briefly composed of a network and a plurality of user equipments (UEs), wherein the network and the UEs support coordinated multipoint transmission/reception (CoMP). In FIG. 1, the network and the UEs are simply utilized for illustrating the structure of the wireless communication system 10. Practically, the network can be an evolved universal terrestrial radio access network (E-UTRAN) comprising a plurality of evolved Node-Bs (eNBs) and relays in a long term evolution-advanced (LTE-A) system, and is not limited herein. Further, each of the plurality of eNBs can manage one or more cells (e.g. cooperating cells), and a relay may also be a cooperating cell. The UEs can be mobile devices such as mobile phones, laptops, tablet computers, electronic books, and portable computer systems. Besides, the network and a UE can be seen as a transmitter or a receiver according to transmission direction, e.g., for an uplink (UL), the UE is the transmitter and the network is the receiver, and for a downlink (DL), the network is the transmitter and the UE is the receiver.

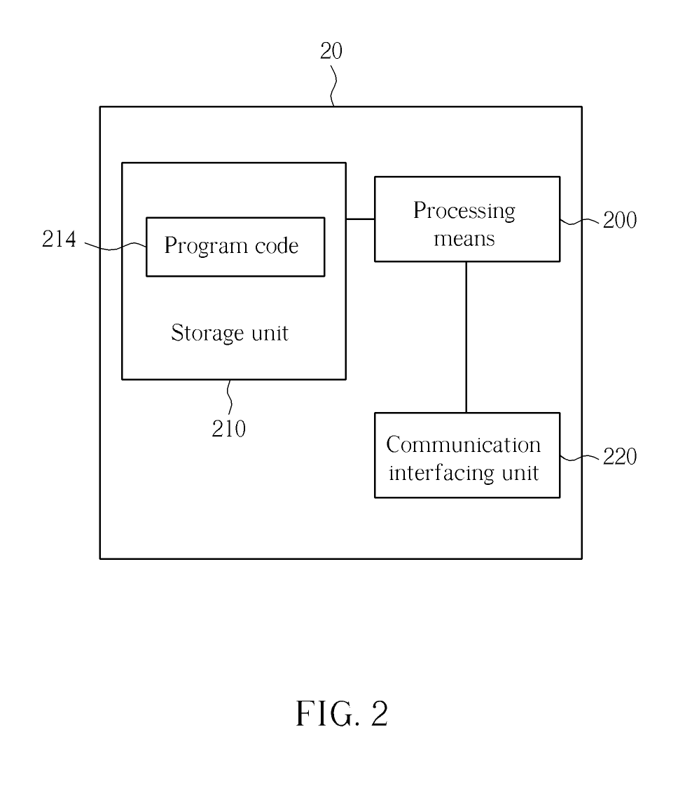

Please refer to FIG. 2, which is a schematic diagram of a communication device 20 according to an example of the present invention. The communication device 20 can be a UE or the network shown in FIG. 1, but is not limited herein. The communication device 20 may include a processing means 200 such as a microprocessor or an Application Specific Integrated Circuit (ASIC), a storage unit 210 and a communication interfacing unit 220. The storage unit 210 may be any data storage device that can store a program code 214, accessed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 is preferably a radio transceiver and can exchange wireless signals with the network according to processing results of the processing means 200.

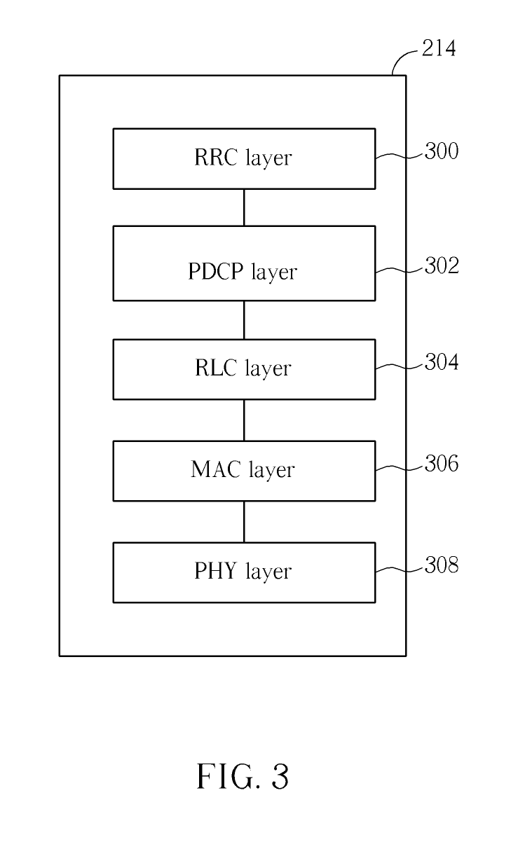

Please refer to FIG. 3, which illustrates a schematic diagram of communication protocol layers for the wireless communication system 10. The behaviors of some of the protocol layers may be defined in the program code 214 and executed by the processing means 200. The protocol layers from top to bottom are a radio resource control (RRC) layer 300, a packet data convergence protocol (PDCP) layer 302, a radio link control (RLC) layer 304, a medium access control (MAC) layer 306 and a physical (PHY) layer 308. The RRC layer 300 is used for performing broadcast, paging, RRC connection management, measurement reporting and control and radio bearer control responsible for generating or releasing radio bearers. The PDCP layer 302 is used for ciphering and integrity protection of transmissions, and maintaining delivery order during a handover. The RLC layer 304 is used for segmentation/concatenation of packets and maintaining delivery sequence when packet loses. The MAC layer 306 is responsible for a hybrid automatic repeat request (HARQ) process, multiplexing logical channels, a random access channel (RACH) procedure and maintaining a UL timing alignment. In each HARQ process, an acknowledgement (ACK) is reported to the network if the MAC data/control packet is received and decoded successfully. Otherwise, a negative acknowledgement (NACK) is reported to the network. The PHY layer 308 is used to provide physical channels. FIG. 3 simply illustrates the behaviors of the protocol layers conceptually, and the behaviors may be different for versions of the LTE-A system.

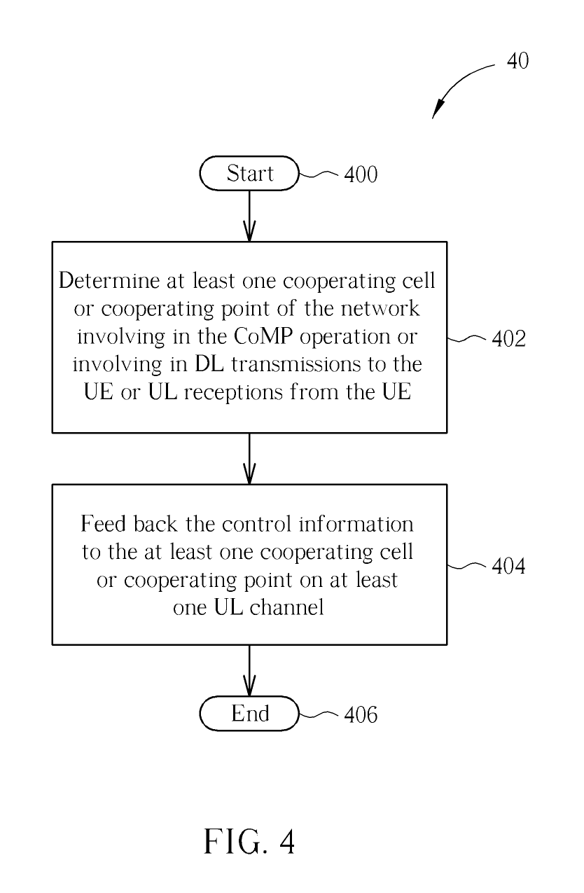

Please refer to FIG. 4, which is a flowchart of a process 40 according to an example of the present invention. The process 40 is utilized in a UE shown in FIG. 1, for handling control information. The UE is configured with a CoMP operation by the network. The process 40 may be compiled into the program code 214 and includes the following steps:

Step 400: Start.

Step 402: Determine at least one cooperating cell or cooperating point of the network involving in the CoMP operation or involving in DL transmissions to the UE or UL receptions from the UE.

Step 404: Feed back the control information to the at least one cooperating cell or cooperating point on at least one UL channel.

Step 406: End.

According to the process 40, the UE first determines the at least one cooperating cell or cooperating point of the network involving in the CoMP operation or involving in the DL transmissions to the UE or the UL transmissions from the UE. Then, the UE feeds back the control information (e.g. corresponding to DL CoMP transmissions) to the at least one cooperating cell or cooperating point on the at least one UL channel (e.g. a physical UL control channel (PUCCH) and/or a physical UL shared channel (PUSCH)). In other words, the UE not only feeds back the control information to a serving cell but also other cells involving in the CoMP operation, the DL transmissions to the UE or the UL transmissions from the UE. Therefore, the cooperating cells do not need to spend time on exchanging the control information, i.e., the other cells obtains the control information from the serving cell, and a coordination latency can be avoided.

Please note that, spirit of the process 40 is that a UE feeds back control information to multiple cooperating cells such that a coordination latency caused by exchanging the control information can be avoided. Detail of realization of the process 40 is not limited. For example, the cooperating cells or cooperating points can be configured to receive or detect (i.e., listen) the control information on a common channel or at least one independent channel. On the other hand, the UE can determine that the cooperating cells or cooperating points involving in the CoMP operation or involving in DL transmissions to the UE or involving UL transmissions, according to a configuration indicated by the network (e.g. the serving cell) or a measurement result obtained by the UE. Further, the configuration may be indicated via signalings such as a CoMP configuration, a transmission and reception mode configuration, a feedback configuration, a scheduling grant and/or a DL assignment, and are not limited. Besides, the cooperating cells or cooperating points can be configured with the same cell identity (e.g. when deploying the network according to the CoMP). Before the UE transmits the control information, the UE can scramble the control information by using the same cell identity for the cooperating cells or cooperating points, or using different identities for the cooperating cells or cooperating points. Besides, UEs without being configured the CoMP operation and the UE being configured the CoMP operation can be assigned independent or non-overlapped identities (i.e., independent UE identities or non-overlapped UE identities in any cooperating cell). The control information may include parameters or information such as an acknowledgement/negative acknowledgement (ACK/NACK), channel quality information (CQI), precoding matrix information (PMI), rank indication (RI) and/or sounding reference signal (SRS). Alternatively, the control information may include parameters or information such as a combination of ACKs/NACKs, CQIs, PMIS, RIs and SRSs in a control information transmission, and are not limited. The UE may be configured to transmit the control information on a common channel or at least one independent channel to the cooperating cells or cooperating points.

Direct feedback to cooperating cell(s) involving in DL CoMP: Instead of passing the UE feedback information from the serving cell to other cooperating cells, the UE feedback information is detected directly by the cooperating cell(s) involving in the transmission(s). For this solution to work properly, the feedback information has to be made reliable to avoid detection errors at cooperating cell(s). (The feasibility of feedback channel(s) configuration (e.g. common or independent) and networking planning for cell identification is considered before configuration.)

Therefore, according to the above illustration and the process 40, when a CoMP operation is configured to a UE and the network including multiple cooperating cells, a serving cell and other cooperating cells does not need to spend time on exchanging control information. Thus, a coordination latency can be avoided, and the CoMP operation can operate regularly to improve signal quality and/or avoid/mitigate the interferences.

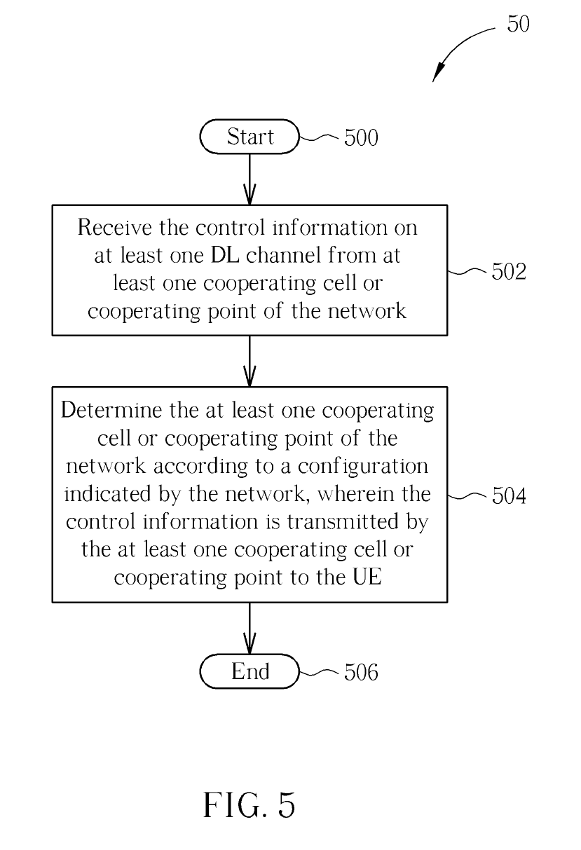

Please refer to FIG. 5, which is a flowchart of a process 50 according to an example of the present invention. The process 50 is utilized in a UE shown in FIG. 1, for handling control information. The UE is configured with a CoMP operation by the network. The process 50 may be compiled into the program code 214 and includes the following steps:

Step 500: Start.

Step 502: Receive the control information on at least one DL channel from at least one cooperating cell or cooperating point of the network.

Step 504: Determine the at least one cooperating cell or cooperating point of the network according to a configuration indicated by the network, wherein the control information is transmitted by the at least one cooperating cell or cooperating point to the UE.

Step 506: End.

According to the process 50, after the UE receive the control information on the at least one DL channel (e.g. a physical DL control channel (PDCCH) and/or a physical DL shared channel (PDSCH)) from the at least one cooperating cell or cooperating point of the network (e.g. only a serving cell or the at least one cooperating cell), the UE can determine the at least one cooperating cell or cooperating point of the network according to the configuration indicated by the network, wherein the control information is transmitted by the at least one cooperating cell or cooperating point to the UE. In other words, the UE can identify from which cell the control information is transmitted. Therefore, the control information can be decoded and performed correctly.

Please note that, spirit of the process 50 is that a UE determines control information according to a configuration indicated by the network such that the UE can identify the control information correctly. Detail of realization of the process 50 is not limited. For example, the UE may be configured to receive or detect the control information on a common channel or at least one independent channel. Besides, the configuration can be indicated via signals such as a CoMP configuration, a transmission and reception mode configuration, a feedback configuration, a scheduling grant and/or a DL assignment, and are not limited.

Therefore, according to the above illustration and the process 50, when a CoMP operation is configured to a UE and the network including multiple cooperating cells, the UE can identify from which cooperating cell the control information is transmitted. Therefore, the control information can be decoded and performed correctly, and the CoMP operation can operate regularly to improve signal quality and/or avoid/mitigate the interferences.

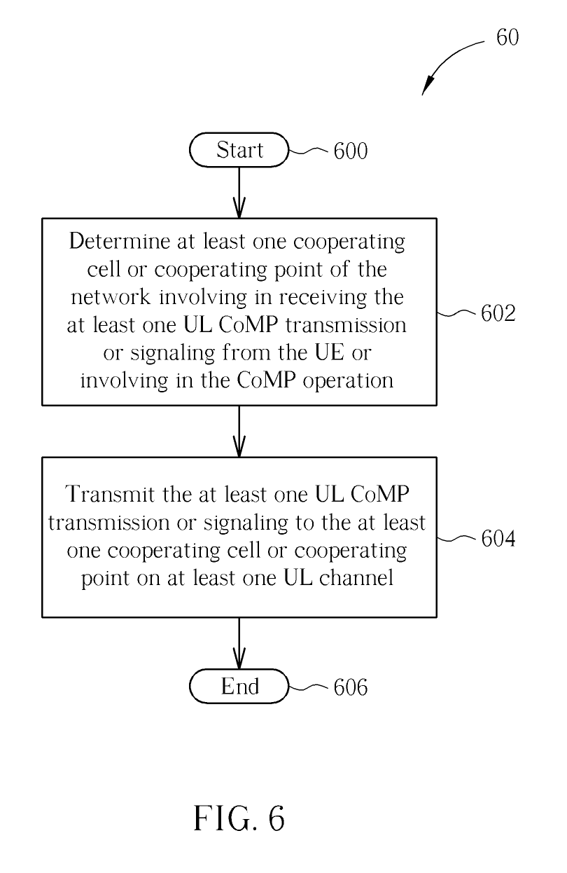

Please refer to FIG. 6, which is a flowchart of a process 60 according to an example of the present invention. The process 60 is utilized in a UE shown in FIG. 1, for handling at least one UL CoMP transmission or signaling. The UE is configured with a CoMP operation by the network. The process 60 may be compiled into the program code 214 and includes the following steps:

Step 600: Start.

Step 602: Determine at least one cooperating cell or cooperating point of the network involving in receiving the at least one UL CoMP transmission or signaling from the UE or involving in the CoMP operation.

Step 604: Transmit the at least one UL CoMP transmission or signaling to the at least one cooperating cell or cooperating point on at least one UL channel.

Step 606: End.

According to the process 60, the UE first determines the at least one cooperating cell or cooperating point of the network involving in receiving the at least one UL CoMP transmission or signaling from the UE or involving in the CoMP operation. Then, the UE transmits the at least one UL CoMP transmission or signaling to the at least one cooperating cell on the at least one UL channel (e.g. a PUCCH and/or a PUSCH). In other words, the UE not only transmits the at least one UL CoMP transmission or signaling to a serving cell but also other cells involving in receiving the at least one UL CoMP transmission or signaling from the UE or involving in the CoMP operation. Therefore, the cooperating cells do not need to spend time on exchanging the at least one UL CoMP transmission or signaling, i.e., the other cells obtains the at least one UL CoMP transmission or signaling from the serving cell, and a coordination latency can be avoided.

Please note that, spirit of the process 60 is that a UE transmits at least one UL CoMP transmission or signaling to multiple cooperating cells (or cooperating points) such that a coordination latency caused by exchanging the at least one UL CoMP transmission or signaling can be avoided. Detail of realization of the process 60 is not limited. For example, the cooperating cells or cooperating points can be configured to receive or detect (i.e., listen) the at least one UL CoMP transmission or signaling on a common channel or at least one independent channel. The UE may be configured to transmit the at least one UL CoMP transmission or signaling on a common channel or at least one independent channel. On the other hand, the UE can determine that the cooperating cells or cooperating points involving in receiving the at least one UL CoMP transmission or signaling from the UE according to a configuration indicated by the network (e.g. the serving cell). Further, the configuration may be indicated via signalings such as a CoMP configuration, a transmission and reception mode configuration, a feedback configuration, a scheduling grant and/or a DL assignment, and are not limited. Besides, the cooperating cells or cooperating points can be configured with the same cell identity (e.g. when deploying the network according to the CoMP). Before the UE transmits the at least one UL CoMP transmission or signaling, the UE can scramble the at least one UL CoMP transmission or signaling by using the same cell identity for the cooperating cells or cooperating points, or using different identities for the cooperating cells or the cooperating points. Besides, UEs without being configured the CoMP operation and the UE being configured the CoMP operation can be assigned independent or non-overlapped identities (i.e., independent UE identities or non-overlapped UE identities in any cooperating cell). On the other hand, the at least one UL CoMP transmission or signaling may be the same or different data transmissions over a UL multiple-input multiple-output (MIMO) configuration.

Therefore, according to the above illustration and the process 60, when a CoMP operation is configured to a UE and the network including multiple cooperating cells (or cooperating points), a serving cell and other cooperating cells does not need to spend time on exchanging at least one UL CoMP transmission or signaling. Thus, a coordination latency can be avoided, and the CoMP operation can operate regularly to improve signal quality and/or avoid/mitigate the interferences.

Please note that, the abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present invention provides a method for transmitting control information and CoMP transmission to cooperating cells (or cooperating points). Therefore, a serving cell and other cooperating cells do no need to spend time on exchanging the control information and the CoMP transmission, and a coordination latency can be avoided. The CoMP operation can operate regularly to improve signal quality and/or avoid/mitigate the interferences.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling control information for a mobile device in a wireless communication system, the mobile device being configured with a coordinated multipoint transmission/reception (CoMP) operation by network of the wireless communication system, the method comprising:
determining at least one cooperating cell or cooperating point of the network involving in the CoMP operation or involving in downlink (DL) transmissions to the mobile device or uplink (UL) receptions from the mobile device; and
feeding back the control information to the at least one cooperating cell or cooperating point on at least one UL channel.

2. The method of claim 1, wherein the at least one cooperating cell or cooperating point is configured to receive or detect the control information on a common channel or at least one independent channel.

3. The method of claim 1, wherein the mobile device determines the at least one cooperating cell or cooperating point involving in the CoMP operation or involving in the DL transmissions to the mobile device or the UL receptions from the mobile device, according to a configuration indicated by the network or a measurement result obtained by the mobile device.

4. The method of claim 3, wherein the configuration is indicated via at least one of a CoMP configuration, a transmission and reception mode configuration, a feedback configuration, a scheduling grant and a DL assignment.

5. The method of claim 1, wherein the at least one cooperating cell or cooperating point is configured with the same cell identity.

6. The method of claim 1, wherein the control information is scrambled by the same cell identity or at least one cell identity of the at least one cooperating cell.

7. The method of claim 1, wherein another mobile device without being configured the CoMP operation and the mobile device are assigned independent or non-overlapped identities.

8. The method of claim 1, wherein the control information comprises at least one of an acknowledgement/negative acknowledgement (ACK/NACK), channel quality information (CQI), precoding matrix information (PMI), rank indication (RI) and sounding reference signal (SRS).

9. The method of claim 1, wherein the control information comprises a combination of ACKs/NACKs, CQIs, PMIS, RIs and SRSs in a control information transmission.

10. The method of claim 1, wherein the mobile device is configured to transmit the control information on a common channel or at least one independent channel to the at least one cooperating cell or cooperating point.

11. A method of handling control information for a mobile device in a wireless communication system, the mobile device being configured with a coordinated multipoint transmission/reception (CoMP) operation by network of the wireless communication system, the method comprising:
receiving the control information on at least one downlink (DL) channel from at least one cooperating cell or cooperating point of the network; and
determining the at least one cooperating cell or cooperating point of the network according to a configuration indicated by the network, wherein the control information is transmitted by the at least one cooperating cell or cooperating point to the mobile device.

12. The method of claim 11, wherein the mobile device is configured to receive or detect the control information on a common channel or at least one independent channel.

13. The method of claim 11, wherein the configuration is indicated via at least one of a CoMP configuration, a transmission and reception mode configuration, a feedback configuration, a scheduling grant and a DL assignment.

14. A method of handling at least one uplink (UL) coordinated multipoint transmission/reception (CoMP) transmission or signaling for a mobile device in a wireless communication system, the mobile device being configured with a CoMP operation by a network of the wireless communication system, the method comprising:
determining at least one cooperating cell or cooperating point of the network involving in receiving the at least one UL CoMP transmission or signaling from the mobile device or involving in the CoMP operation; and
transmitting the at least one UL CoMP transmission or signaling to the at least one cooperating cell or cooperating point on at least one UL channel.

15. The method of claim 14, wherein the at least one cooperating cell or cooperating point is configured to receive or detect the at least one UL CoMP transmission or signaling on a common channel or at least one independent channel.

16. The method of claim 14, wherein the mobile device is configured to transmit the at least one UL CoMP transmission or signaling on a common channel or at least one independent channel.

17. The method of claim 14, wherein the mobile device determines that the at least one cooperating cell or cooperating point involves in receiving the at least one UL CoMP transmission or signaling from the mobile device according to a configuration indicated by the network, and the configuration is indicated via at least one of a CoMP configuration, a transmission and reception mode configuration, a feedback configuration, a scheduling grant and a DL assignment.

18. The method of claim 14, wherein the at least one cooperating cell or cooperating point is configured with the same cell identity.

19. The method of claim 14, wherein the at least one UL CoMP transmission or signaling is scrambled by the same cell identity or at least one cell identity of the at least one cooperating cell.

20. The method of claim 14, wherein another mobile device without being configured the CoMP operation and the mobile device are assigned independent or non-overlapped identities.

21. The method of claim 14, wherein the at least one UL CoMP transmission or signaling is the same or different data transmissions over a UL multiple-input multiple-output (MIMO) configuration.
